(19) United States
(12) Patent Application Publication
(10) Pub. No.: US 2010/0068358 A1
(43) Pub. Date: Mar. 18, 2010

(54) METHOD AND DEVICE FOR PRODUCING PORTIONS OF A STRING FOOD PRODUCT

(75) Inventor: Jacques Le Paih, Plumeliau (FR)

Correspondence Address: ZARLEY LAW FIRM P.L.C., CAPITAL SQUARE, 400 LOCUST, SUITE 200, DES MOINES, IA, 50309-2350, US

(73) Assignee: STORK TOWNSEND B.V., Oss (NL)

(21) Appl. No.: 12/514,848

(22) PCT Filed: Nov. 14, 2007
(86) PCT No.: PCT/FR07/01873

§ 371 Date: Jul. 28, 2009

(30) Foreign Application Priority Data
Nov. 17, 2006 (FR) 0610102

(51) Int. Cl. A23L 1/317; B65B 25/06; A23L 1/31; B26D 1/00; B26D 7/00

(52) U.S. Cl. 426/277; 426/518; 426/392; 426/278; 99/537; 83/694; 83/167; 83/932

(57) ABSTRACT

The invention relates to a method and a device for the production of portions of a food product, in particular of the meat type, in the shape of a string, and particularly sausage-type portions from a main sausage, comprised of minced meat or fish and/or vegetables, covered with a skin obtained by calcium gelling of a hydrocolloid. The method comprises the production of at least a string (8) of the food product, the substantially vertical hanging of the end portion (81) of the said string, and obtaining portions of said string by cutting said hanging end portion so as to obtain portions (6) which are separated from the string by gravity.

The present invention relates to the manufacturing of portions of a food product, particularly of meat type, in the form of a strand, and particularly the manufacturing of sausage-type portions from a bead, comprised of minced meat or fish and/or vegetables, covered by a skin obtained by calcic gelling of a hydrocolloid.

There has been proposed in patent document FR 2 852 207, a bulk of minced meat in the form of small portions or sections comprising a core of minced meat coated with an outer envelope of gelled hydrocolloid material, this outer envelope limiting the agglomeration of the small portions with each other. The bulk is obtained by cutting small-length portions from a plurality of beads or strands of minced meat, extruded parallely and covered by a gelled hydrocolloid, by successive spraying of hydrocolloid and then gelling agent. The strands resting on a conveyor belt are simultaneously split into portions with a unique cutting tool. The cutting tool, formed for example of a multi-bladed wheel, is arranged above said conveyor belt such that the strands are pinched between the conveyor belt and the blades.

This type of cutting tool does not ensure a good separation of the portions with respect to each other. In fact, due to their small section and their light weight, the portions tend to remain glued to the conveyor belt and/or to the cutting tool. Moreover, such a cutting tool operating by pinching cannot efficiently cut the nerves of the meat, and particularly the aponeuroses.

There has also been known, particularly from patent document WO02/060264, the manufacturing of sausage-type portions by coextrusion of a bead coated with a starting base comprising one or several hydrocolloids, such as sodium pectate or alginate, pectin, carraghenates, etc., which base is intended to form the skin by calcic gelling in a bath downstream from the coextrusion means. In a continuous manufacturing method, several beads are coextruded parallely and according to a same coextrusion speed via a plurality of transversely aligned coextrusion heads, the beads transit in a gelling bath extending horizontally, and are brought side by side to then be put into portions by same means transversely acting on the assembly of said beads, in order to form batches of identical products perfectly gathered and aligned to be loaded in their packaging tray. The portioning means comprise two same synchronised endless bands arranged on top of each other such as to form a passage therebetween that vertically narrows from upstream to downstream for said beads. The endless bands comprise transversal cleats passing facing each other in said passage so as to progressively pinch said beads from upstream to downstream to drive out the meat from each side, and to completely flatten the skin on itself over the pinching length, and eventually transversely section the beads.

This system for portioning may prove to be satisfying for the manufacturing of sausage-type portions, having typically diameters of about 2 cm or more, and lengths of at least 15 cm. Nevertheless, such a system for portioning, consisting in driving out the meat to then only section the outer envelope may prove to be inappropriate for manufacturing portions of reduced sections and length, and in any event these small portions would as aforementioned tend to stick to the cleats.

The aim of the present invention is to propose a new method for manufacturing portions from a strand of food product, particularly sausage-type portions, from a strand-type bead of meat-type food product, ensuring a good separation of the portions, particularly in the case of small-sized portions.

To this end, the object of the present invention is a method for manufacturing portions of a food product, particularly of meat-type, in the form of a strand, characterized in that it comprises
a) manufacturing of at least one strand of food product
b) the fact of freely substantially vertically hanging the end portion of said strand, and
c) portioning said strand by cutting said hanging end part, so as to obtain portions that separate from the strand by gravity, intended to be packaged in packaging trays, said portions separating from the strand being advantageously transferred by gravity into the packaging trays.

This principle of cutting the hanging end part of the method according to the invention makes it possible to ensure an efficient portioning of any strand-type food product, particularly in the case of manufacturing small portions, having for example a substantially circular transverse section having a diameter of less than 10 milimeters, and a weight of less than 10 grams, even less than 5 grams, for example about 2 g.

According to a feature, said cuttings at step c) are carried out by shearing, and in the case of several strands, each hanging end part is preferably cut individually by shearing, in order to particularly ensure that the nerves be cut in the case of a meat-type product.

According to an embodiment, in the case of manufacturing sausage-type portions, step a) comprises the continuous manufacturing of at least one bead comprising minced meat and/or fish and/or vegetables, covered by a skin obtained by calcic gelling of one or several hydrocolloids. Presently, by “sausage-type portion”, is meant any product formed by a bead covered with an outer envelope or skin obtained by calcic gelling of a hydrocolloid, particularly the products typically named sausage, whereof the function of the outer envelope is to maintain the shape of the sausage before and during cooking, as well the products of the type described in the aforementioned French patent document, whereof the function of the outer envelope is simply to limit the agglomeration of the products with each other.

According to an embodiment, step a) comprises the continuous and parallel coextrusion of several beads coated with a starting base comprising one or several hydrocolloids and the calcic gelling of the starting base of said beads, preferably by passing said coated beads in a gelling bath, the hanging end parts of the beads covered by their skin that result from step c) hang freely substantially parallel to each other, said hanging parts being cut individually and preferably simultaneously.

In the case of small transverse section portions, the portions may be directly loaded in bulk in the trays. In the case of batch packaging of arranged portions, the beads are individually and simultaneously cut, to form successive batches of portions, the portions of each batch being brought together transversely side by side and brought together substantially horizontally to be loaded in their packaging tray.

The aim of the present invention is also a device for the implementation of the method for manufacturing portions as described previously, characterized in that it comprises manufacturing means for manufacturing at least one strand of food product, means able to hang, substantially vertically, the end part of said strand, in the operating range of the portioning means, and portioning means able to cut said hanging end part, such that the portions separate from the strand by gravity.

According to another feature, the means for portioning are able to act on both sides of the hanging end part to cut by shearing.

According to another feature, each strand is cut by an individual cutting system, said portioning means comprising for each hanging end part to cut at least one pair of shears, each pair of shears being capable of taking the hanging end part of a bead between its blades.

According to a feature, the portioning means are capable of progressively individually pinching the end part like a diaphragm then cut it by shearing, said portioning means comprising for each hanging end part to cut two pairs of shears arranged facing each other such that the four blades of the two pairs form a diaphragm type system.

According to an embodiment, the device comprises means for continuously manufacturing at least one bead, comprising minced meat and/or fish and/or vegetables, covered by a skin obtained by calcic gelling of one or several hydrocolloids.

According to an embodiment, said manufacturing means comprise continuous and parallel coextrusion means, and preferably at a same coextrusion speed, of several beads coated with a starting base comprising one or several hydrocolloids, and calcic gelling means for calcic gelling of said hydrocolloid or hydrolloids, preferably by immersion of said coated beads in a gelling bath,
said means for hanging, comprising for example a downstream drum at the output of the gelling means, being capable to hang the end parts of the beads covered by their skin, substantially parallel to each other
said portioning means being capable to individually and preferably simultaneously cut the hanging end parts, said means being advantageously formed of several pairs of shears transversely aligned or several transversely aligned assemblies, each assembly comprising two pairs of shears facing each other for forming a diaphragm type system.

Advantageously, the device comprises packaging means capable of recovering the portions that fall from said portioning means to load them in the packaging trays.

In the case of bulk, the packaging means may comprise one simple hopper under the portioning means. In the case of packaging by batches of arranged portions, the portioning means are advantageously capable of individually and simultaneously cutting the beads to form successive batches of portions, the packaging means comprising a chute capable of recovering the successive batches of portions that fall vertically, orienting them gradually substantially horizontally, while progressively moving them towards each other and in contact with each other, in order to load them by gravity in trays.

The invention will be better understood, and other objects, details, characteristics and advantages will become more apparent in the following detailed explanatory description of two currently-preferred particular embodiments of the invention, with reference to the accompanying schematic drawings, in which:

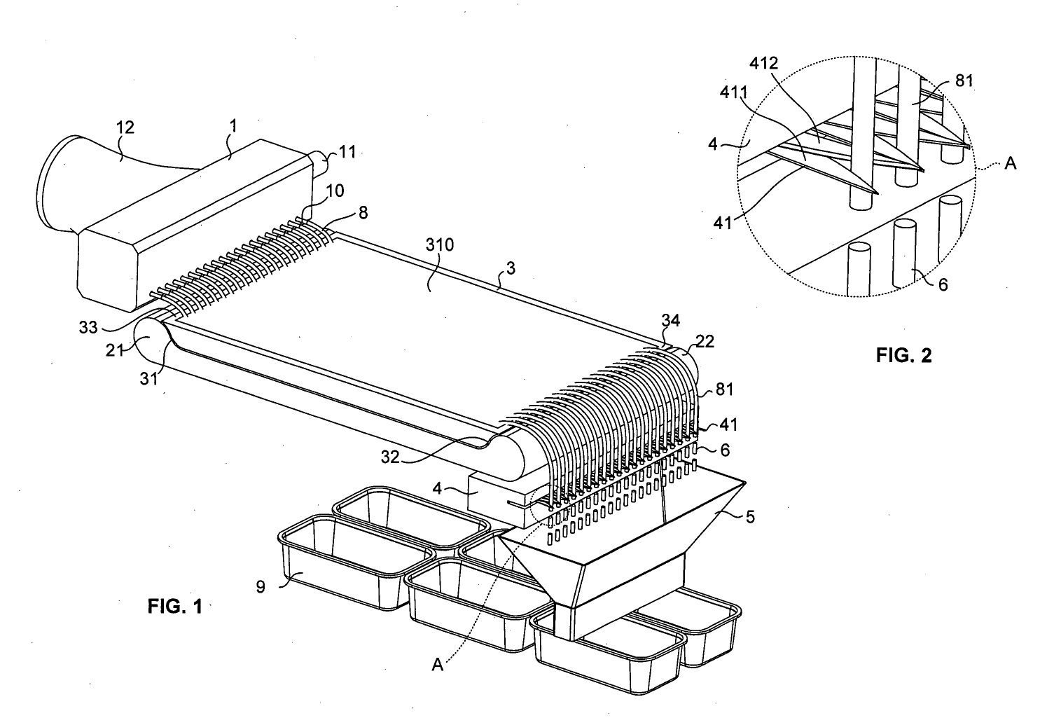

FIG. 1 is a schematic perspective view of a device for manufacturing sausage-type portions according to a first embodiment of the invention;

FIG. 2 is an enlarged view of detail A of FIG. 1, showing the cutting means;

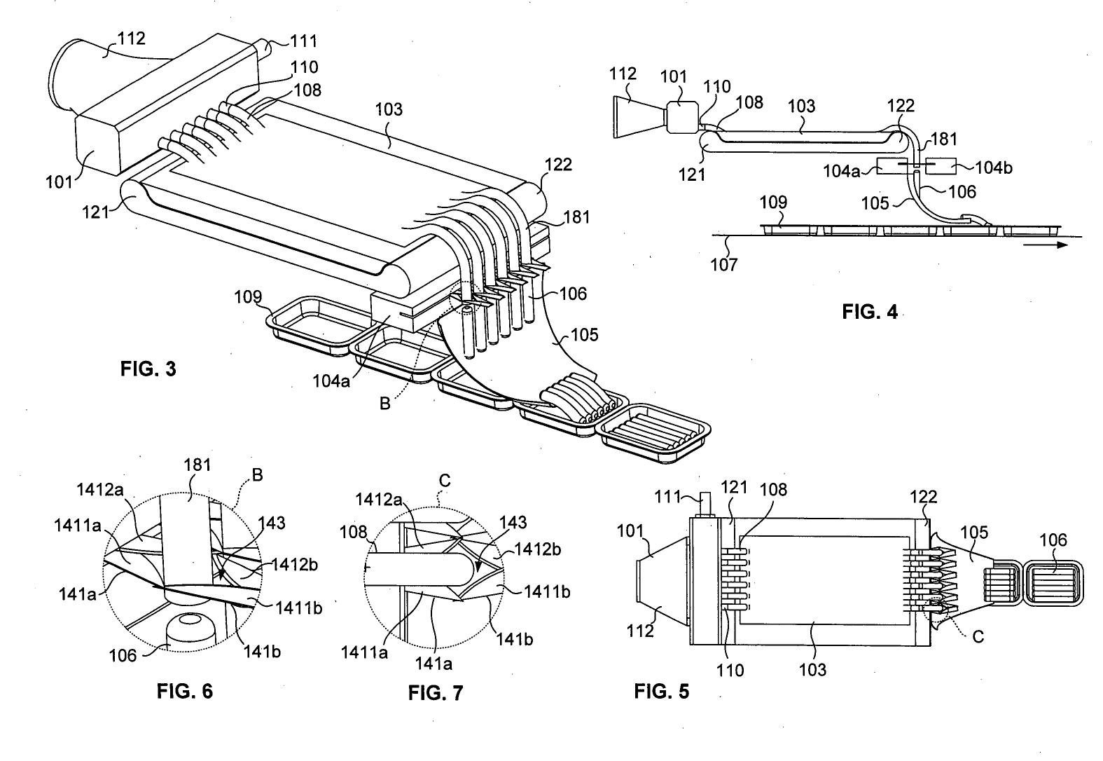

FIG. 3 is a schematic perspective view of a device for manufacturing sausage-type portions according to a second embodiment of the invention;

FIGS. 4 and 5 are small-scale views, respectively side and top views of the device in FIG. 3; and

FIGS. 6 and 7 are respectively enlarged view of detail B of FIG. 3 and detail C of FIG. 5.

FIG. 1 shows a device intended for manufacturing small sausage-type portions, for example having a diameter of about 5 millimeters and about 2 grams each, intended to be transferred in bulk in trays, said portions being obtained from a plurality of beads 8 of minced meat covered by a skin in hydrocolloid material, coextruded in parallel.

The device comprises at its upstream end, a coextrusion system 1 comprisisng a plurality of identical coextrusion heads 10 transversely aligned, 20 heads in the present embodiment. The extrusion system comprises an inlet 11 for its supply in hydrocolloid product, such as sodium alginate, and an inlet 12 for its supply in minced meat. The coextrusion system comprises adjusting means to adjust the flow rate of hydrocolloid product and the flow rate of minced meat towards each of said coextrusion heads, such that the coextrusion speed is substantially identical on the assembly of coextrusion heads.

The device comprises an upstream driving drum 21 of horizontal axis and a downstream driving drum 22 of horizontal axis, respectively arranged upstream and downstream from a gelling tub 3, the gelling tub comprising for example a calcium lactate-based gelling bath 310. The coextrusion heads are arranged parallely and slightly above the upstream drum 21 such that when the beads exit the coextrusion heads, they come to rest by gravity on this upstream drum to be brought in the gelling tub. On exiting the tub, the beads are taken over by the downstream drum 22. The drums are driven by a motor at a rotational speed corresponding to the coextrusion speed, so as to positively drive the beads formed by the coextrusion heads. Alternatively, the device only comprises a downstream drum exiting the gelling tub, the beads being directly extruded in the upstream end of the gelling tub.

Tub 3 is of a shallow-type, has a flat bottom, and extends longitudinally; its length being determined according to the coextrusion speed and the passage time or immersion time required for the beads 8 formed at the output of the coextrusion heads 10 in the gelling bath. For a better guiding of the beads entering and exiting the tub, the tub comprises slanted or curved upstream 31 and downstream 32 lateral walls extending respectively by substantially horizontal upstream 33 and downstream 34 rims, the upstream and downstream drums being arranged substantially tangentially to said upstream and downstream rims. In tub 3, guide passageways (not shown) may be formed in the longitudinal alignment of the coextrusion heads 10 to individually guide the beads parallely to each other. The tub may comprise delivery and suction conduits gathered in a recycling circuit of the gelling bath, and arranged such as to create a flux or stream in the gelling bath, that will contribute to move the beads 8 forward. Advantageously, as soon as they exit from the coextrusion heads, the beads are sprayed with a gelling agent, a flux of a calcium lactate solution falling for example on each bead.

According to an embodiment, both drums constitute upstream and downstream guide rollers of a cut-out endless band, for example in the shape of a grid. The upper strand of the endless band is guided by lateral edges to pass into the tank, near to its bottom wall. The beads rest on the upper strand of the endless band, at least one of the two rollers is rotationally driven such that the moving speed of the endless band substantially corresponds to the extrusion speed of the beads to drive the beads positively.

The downstream drum, whereon an endless band may be wound, constitutes the hanging means according to the invention, for hanging the beads. At the output of the tub, the beads are received on the downstream drum, they are partially wound on it, on an angular sector of about 90° or less, and fall freely substantially vertically. Each bead thus exhibits when exiting the downstream drum a hanging end part 81, arranged substantially vertically, that hangs freely in the air. The spacing pitch between the beads remains substantially identical, from the exit of the extrusion heads to the exit of the downstream drum.

The device comprises portioning means arranged under the downstream drum, such that the hanging end parts 81 come naturally by gravity in the operating range of the portioning means. The portioning means comprise twenty transversely aligned pairs of shears 41, each pair of shears, also called dual-blade shears, being capable of receiving between its two blades in the open position, a hanging end part 81 of a bead. Each pair of shears comprises two sharp plane blades 411, 412, arranged horizontally, mounted articulating around a vertical hinge axis, and operable between an open position, better visible in FIG. 2, and a closed position to cut a hanging end part placed between the two blades, by shearing. The pairs of shears are mounted articulating on a same holder ramp 4, and operated simultaneously, by joint actuating means (not shown), between their open position and their closed position to simultaneously cut the end parts of the twenty beads, in substantially identical portions 6. In the open position, the pairs of adjacent shears are in contact by the external edges of their blades.

For loading the portions 6 in trays 9, the device comprises a hopper-type collector 5 extending transversely to recover the totality of the portions obtained from the twenty beads, and orient them towards the trays. The upstream and downstream drums, tub, holder ramp 4 as well as the hopper may possibly be mounted on a same support frame. A conveyor belt (not shown) conveys the trays 9 and makes them pass in loading position, immediately under the hopper. The trays are arranged on the conveyor belt edge-to-edge, in one or several parallel rows, for example in two parallel rows as shown in FIG. 1, the conveyor belt operating step by step or continuously. The hopper is advantageously transversely compartmented so as to form channels capable of orienting the portions towards the trays, the number of channels corresponding to the number of rows of trays.

In operation, the beads 8 formed at the output of the coextrusion head 10 arrive on the upstream drum 21, cross the gelling bath, and are taken over by the downstream drum 22 to be hung, parallely to each other. Each hanging end part 81 is cut individually into portions by a pair of shears, the cut portions falling by gravity in the hopper to be loaded in the trays.

FIGS. 3, 4 and 5 show a device for the manufacturing of sausage-type portions 106, such as merguez or chipolata sausages, of more standard dimensions, having for example a diameter of about 2 centimeters and a length of 15 to 20 centimeters, typically of 16.5 cm. These portions, obtained as previously from beads coextruded in parallel, are intended to be loaded in trays per batches of identical portions, perfectly gathered and aligned.

As previously, the device comprises a coextrusion system 101, an upstream driving drum 121, a downstream driving drum 122, and a gelling tub 103. The coextrusion system comprises six transversely aligned coextrusion heads 110, as well as an inlet 111 and an inlet 112, respectively, for the supply in hydrocolloid product and in minced meat. At the exit of the coextrusion heads, the six beads 108 arrive on the upstream drum 121, cross the gelling tub 103, and are taken over at the exit of the tub by the downstream drum 122, the latter allowing the end parts 181 of the six beads to hang freely.

In this embodiment, the portioning means comprise for each hanging end part a system of two pairs of shears 141a, 141b arranged facing each other such that the four blades 141a, 1412a, 1411b, 1412b of the two pairs of shears form a diaphragm type system. As better visible on FIGS. 6 and 7, the hanging end part 181 of a bead hangs freely in the passage 43 formed between the four blades of the two pairs of shears in the open position. The two pairs of shears are operated simultaneously from their open position towards their closed position, such as to obtain a progressive closure of the passage. The hanging end part 181 is thus progressively pinched between the four blades and then sectioned. This diaphragm-type cutting system, for each bead, make it possible to obtain portions 106 with rounded ends, as shown particularly in FIG. 6.

The device thus comprises six pairs of shears mounted on a first holder ramp 104a, and six other pairs of shears, coming to face the previous ones and mounted on a second holder ramp 104b, to form six systems of two pairs of shears facing each other, this second holder ramp 104b being represented uniquely on FIG. 4, solely the sharp parts of the pairs of shears of this second ramp being represented on FIGS. 3 and 5.

The two pairs of shears facing each other of the six systems are simultaneously and alternatively controlled between their closed position and their open position to form successive batches of six identical portions 106 falling simultaneously.

The device comprises a chute-shaped collector 105 making it possible to recover the successive batches of six portions 6 falling vertically, and orient them progressively substantially horizontally, while progressively transversely moving them towards each other, in order to load them in trays. The chute extends longitudinally on an angular sector of around 90° and exhibits a transversal section that progressively narrows from its substantially vertical upstream part towards its substantially horizontal downstream part. For the loading of the portions 106 into the trays 109, a conveyor belt 107 represented schematically on FIG. 4, transports trays behind each other, along a row, in the same direction as the beads extrusion direction, and makes them pass into a loading position, immediately under the downstream end of the chute. The batch of six portions 106 that has just been cut is transferred by gravity in the trays. The six portions fall simultaneously in the chute, slide over it, and are arranged by mere gravity in a side-by-side contact, in a tray.

1. Method for manufacturing portions of a food product, and particularly a meat type product, in the form of a strand, characterised in that it comprises
a) manufacturing of at least one strand (8, 108) of food product,
b) the fact that the end part (81, 181) of said strand is made to hang freely, substantially vertically, and
c) portioning said strand by cutting said hanging end part, so as to form portions (6, 106) that separate from the strand by gravity, said cuts being made by shearing.

2. Method according to claim 1, characterised in that the portions separating from the strand by gravity in step c) are recovered so as to be loaded by gravity into packaging trays.

3. Method according to claim 1, characterised in that the step a) comprises the manufacturing of at least one strand with a substantially circular transverse section having a diameter of less than 10 mm, the cuts of the hanging end parts in the step c) being performed so as to obtain portions of less than 10 grams.

4. Method according to claim 3, characterised in that the cuts of the hanging end parts in the step c) are performed so as to obtain portions of less than 5 grams.

5. Method according to claim 1 for manufacturing sausage type portions, characterised in that step a) comprises continuous manufacturing of at least one bead (8, 108) comprising minced meat and/or fish and/or vegetables, covered by a skin obtained by calcic gelling of one or several hydrocolloids.

6. Method according to claim 1, characterised in that step a) comprises continuous and parallel coextrusion of several beads (8, 108) coated with an starting base comprising one or several hydrocolloids and calcic gelling of the starting base of said beads, the hanging end parts (81, 181) of the beads being covered with their skin and resulting from step c) hang freely substantially parallel to each other, said hung parts being cut individually.

7. Method according to claim 6, characterised in that in step c), the beads (8, 108) are cut individually and simultaneously to form successive batches of portions, the portions of each batch being brought together transversely side by side and brought together approximately horizontally to be loaded in their packaging tray.

8. Device for implementing the portion manufacturing method according to claim 1, characterized in that it includes means (1, 3, 101, 103) for manufacturing at least one strand (8, 108) of food product, means (22, 122) capable of making the end part (81, 181) of said strand hang substantially vertically, and means for portioning (41, 141a, 141b) capable of cutting said hanging end part such that the portions separate from the strand by gravity, said means for portioning (41, 141a, 141b) being capable of acting on each side of the hanging end part (81, 181) to make cuts by shearing.

9. Device according to claim 8, characterized in that said means for portioning comprise at least one pair of shears (41, 141a, 141b) for each hanging end part (81, 181) to be cut, each pair of shears being capable of taking the hanging end part of a bead between its blades (411, 412, 1411a, 1412a, 1411b, 1412b).

10. Device according to claim 9, characterised in that said means for portioning comprise two pairs of shears (141a, 141b) for each hanging end part (181) to be cut, arranged facing each other such that the four blades (1411a, 1412a, 1411b, 1412b) of the two pairs of shears form a diaphragm type system.

11. Device according to claim 8, characterised in that the manufacturing means (1, 3) are capable of manufacturing at least one strand (8) of food product substantially circular having a diameter of less than 10 millimeters.

12. Device according to claim 8 for manufacturing of sausage type portions, characterised in that it comprises means (1, 101, 3, 103) for continuously manufacturing at least one bead (8, 108), comprising minced meat and/or fish and/or vegetables, covered by a skin obtained by calcic gelling of one or several hydrocolloids.

13. Device according to claim 12, characterised in that said manufacturing means comprise means (1, 101) for continuously coextruding in parallel several beads coated with a starting base comprising one or several hydrocolloids, and means (3, 103) for calcic gelling of said hydrocolloids, said means (22, 122) for making the end part hang being capable of making the end parts (81, 181) of the beads (8, 108) covered by their skin hang substantially parallel to each other, said means for portioning (41, 141a, 141b) being capable of individually cutting the hanging end parts.

14. Device according to claim 13, characterised in that it comprises means (5, 105, 107) for putting into trays, capable of recovering portions that fall from said means for portioning to place them in packaging trays (9, 109).

15. Device according to claim 14, characterised in that the means for portioning are capable of cutting beads individually and simultaneously to form successive batches of portions, the means for putting into trays comprising a chute (105) capable of recovering successive batches of portions (106) falling vertically, progressively orienting them substantially horizontally while progressively moving them towards each other and into contact with each other, so as to load them by gravity into packaging trays (109).

16. Device according to claim 14, characterised in that means for putting into trays comprise a hopper-type collector (105) under the portioning means for recovering the portions and directing them to packaging trays.
